(19) United States
(12) Patent Application Publication
(10) Pub. No.: US 2010/0054906 A1
(43) Pub. Date: Mar. 4, 2010

(54) RACKING SYSTEM AND METHOD OF STORING PALLETIZED ITEMS

(75) Inventors: Dennis Hartman, South Bend, IN (US); John Terry, Scotts Valley, CA (US)

Correspondence Address: BARNES & THORNBURG LLP, P.O. BOX 2786, CHICAGO, IL, 60690-2786, US

(73) Assignee: J&D GLOBAL, LTD., South Bend, IN (US)

(21) Appl. No.: 12/373,177

(22) PCT Filed: Jul. 11, 2007
(86) PCT No.: PCT/US07/73232

§ 371 Date: Nov. 16, 2009

Related U.S. Application Data
(60) Provisional application No. 60/806,970, filed on Jul. 11, 2006.

(51) Int. Cl. A47F 5/00; A47B 81/00; B65G 1/04

(52) U.S. Cl. 414/807; 211/134

(57) ABSTRACT

The present disclosure relates to a racking system and method of storing palletized items in the racking system. The present disclosure also relates to a racking system for storing multiple pallets stacked with the palletized items, the multiple pallets being deliverable for storage in the racking system by a fork lift vehicle.

### BACKGROUND

The present disclosure relates to a racking system and method of storing palletized items in the racking system. More particularly, the present disclosure relates to a racking system for storing multiple pallets stacked with palletized items and delivered for storage by a fork lift vehicle.

### SUMMARY

In accordance with the present disclosure, a racking system for storing palletized items, includes a pair of vertically-disposed side supports, which may be substantially parallel to one another, having a plurality of vertically-disposed and laterally-spaced apart pairs of posts. The posts of the side supports are laterally-spaced-apart at a first separation distance to accommodate the entrance of a fork-lift vehicle therebetween and to define a lower storage space for receiving and storing a lower group of palletized items stacked on pallets. The pallets are arranged in a three-pallet-wide, side-by-side configuration arranged to fit between the pair of side supports.

In an illustrative embodiment, the racking system includes a plurality of horizontally-disposed and co-planar overhead support platforms each having an outer end secured to one of the side supports. The outer ends extend towards one of the support platforms and inner ends of the plurality of support platforms terminate short of each other in spaced-apart relationship to define a second separation distance. The second separation distance provides a clearance space to accommodate the entrance of a vertically-extendable mast of the fork-lift vehicle. The support platforms and inner ends at least further define an upper storage space over the support platforms for receiving and storing an upper group of palletized items stacked on pallets arranged in the three-pallet-wide, side-by-side configuration and arranged to fit between the pair of side supports.

In an illustrative embodiment, the support platforms each include a support member, which may be T-shaped, secured on the posts and the support members extend toward one another from each of the posts. Each support member is sized to underlie and support a full width of one of the three side-by-side pallets and a first or end portion of a middle pallet of the three side-by-side pallets, and a second or intermediate portion of the middle pallet lying between the end portions spans the second separation distance.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a racking system, according to the present disclosure, showing upper and lower groups of palletized items in a three-pallet-wide, side-by-side configuration stored in the racking system, the upper group having two of the three pallets fully supported by support platforms and a middle pallet spanning a clearance space between support members of the support platforms;

FIG. 2 is a front elevational view of the racking system of FIG. 1, showing a connected series of racking systems with palletized items or cartons stored therein and showing a fork-lift vehicle loading an upper group of a three-pallet-wide, side-by-side configuration of palletized items on the support platforms of the racking system; and

FIG. 3 is a perspective view showing a plurality of forks of the fork-lift vehicle of FIG. 2, the plurality of forks being mounted to a carriage of a vertical mast of the fork-lift vehicle, the forks configured to engage and lift the three-pallet-wide, side-by-side configuration of pallets.

### DETAILED DESCRIPTION

While the present disclosure may be susceptible to embodiment in different forms, there is shown in the drawings, and herein will be described in detail, embodiments with the understanding that the present description is to be considered an exemplification of the principles of disclosure and is not intended to be exhaustive or to limit the disclosure to the details of construction and the arrangements of components set forth in the following description or illustrated in the drawings.

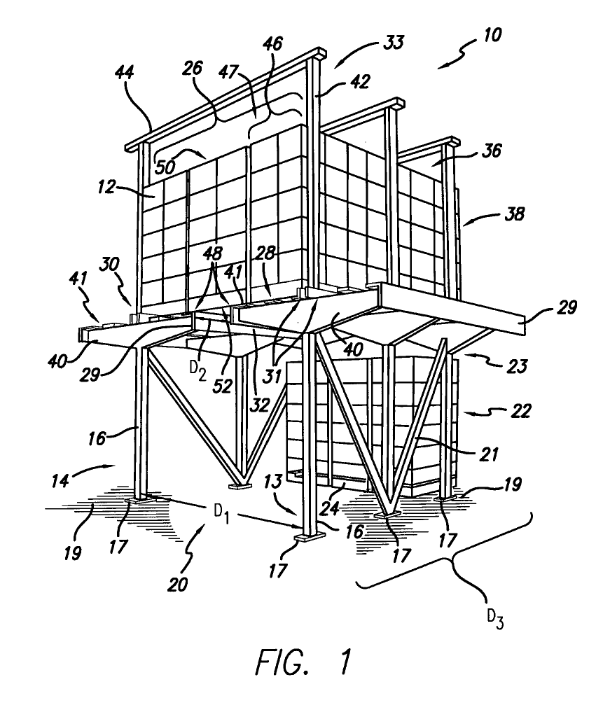

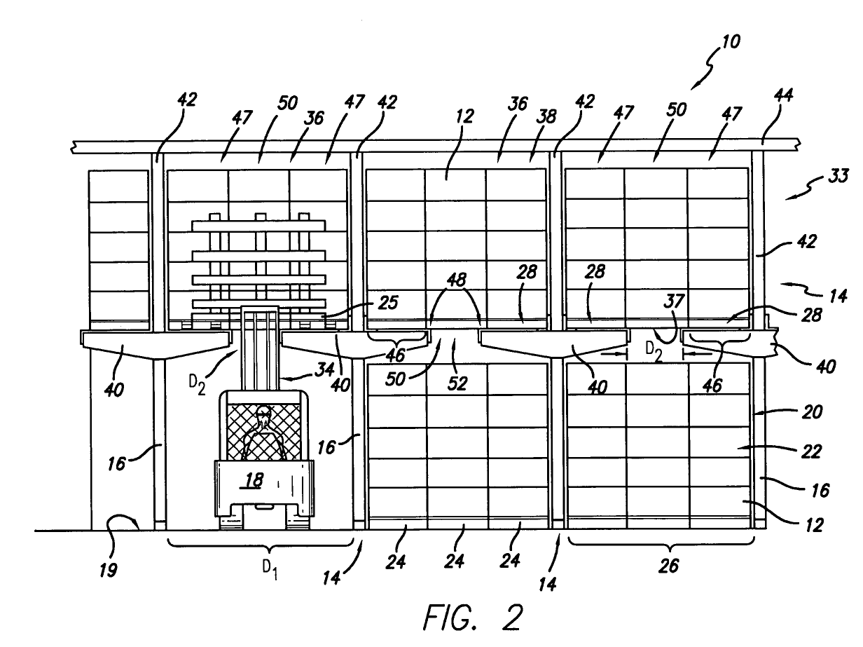

As suggested in FIGS. 1 and 2 and in accordance with the present disclosure, a racking system 10 for storing palletized items 12 comprises a frame assembly 13 including at least a pair of vertically-disposed side supports 14, which side supports 14 may be aligned substantially parallel to one another. Further included is a plurality of horizontally-disposed and co-planar overhead support platforms 28. Side supports 14 include a plurality of vertically-disposed and laterally-spaced-apart pairs of posts 16. Posts 16 of the side supports 14 are laterally-spaced-apart at a first or lower separation distance D₁ to accommodate the entrance of a fork-lift vehicle 18 therebetween and to define a lower storage space 20 for receiving and storing a lower group of palletized items 22 stacked on pallets 24. The pallets 24 are arranged in a three-pallet-wide, side-by-side configuration 26 arranged to fit between the pair of side supports 14.

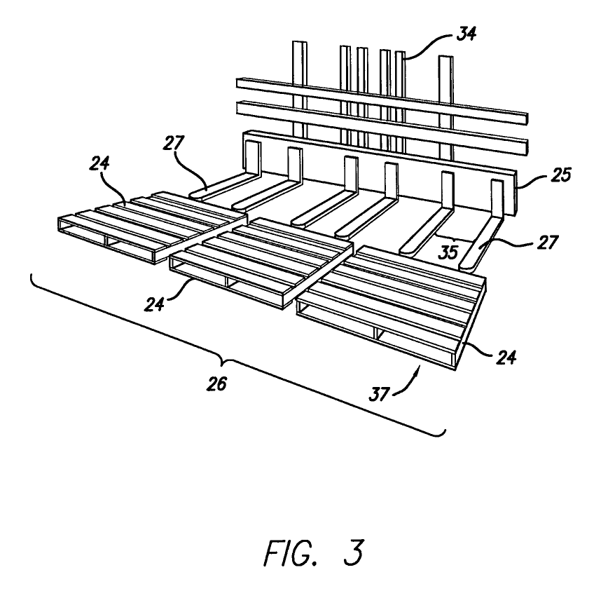

In an illustrative embodiment, each of the support platforms 28 include an outer end 30 secured to one of the side supports 14. The outer ends 30 extend towards one of the support platforms 14 and inner ends 32 of an innermost of the plurality of support platforms 28 terminate short of each other in spaced-apart relationship to define a second or upper separation distance D₂. The second separation distance D₂ provides a clearance space to accommodate the entrance of a vertically-extendable mast 34 of the fork-lift vehicle 18, as suggested in FIGS. 2 and 3. The inner ends 32 further define an upper storage space 36 over the support platforms 28 for receiving and storing an upper group of palletized items 38 stacked on pallets 24 arranged in the three-pallet-wide, side-by-side configuration 26 and arranged to fit between the pair of side supports 14.

In an illustrative embodiment, the support platforms 28 each include an upper support member 40 secured on posts 16, which support member 40 may be T-shaped, as shown in FIGS. 1 and 2. Support member 40 may be shaped in a variety of different configurations (not shown). Support members 40 extend toward one another from each of the posts 16. Each support member 40 is sized to underlie and support a full width 46 of one of the three side-by-side pallets 24, for example, an end pallet 47, and a first or end portion 48 of a middle pallet 50 of the three side-by-side pallets 24, and a second or intermediate portion 52 of the middle pallet 50 lying between the first portions 48 spans the second separation distance D₂.

In an illustrative embodiment, support member 40, support platforms 28 and second separation distance D₂ cooperate to comprise a means for supporting a full width of the group of palletized items 38. The group of palletized items 38 is stacked on three pallets 24, the three pallets 24 being arranged in the three-pallet-wide, side-by-side configuration 26 in the upper or second storage space 36 located above the first or lower storage space 20.

In accordance with the present disclosure and as shown in FIG. 2, a connected series of the racking system 10 of FIG. 1 are adapted to be secured to a floor 19 of a building to provide increased storage capacity. This is accomplished by having palletized items 12 arranged in the three-pallet-wide, side-by-side configuration 26 stored in the lower and upper storage spaces 20, 26, respectively of each of the rack systems 10. As suggested in FIGS. 2 and 3, individual pallets 24 are loaded and delivered by fork-lift vehicle 18 for storing in the multi-tiered rack system 10.

Racking system 10 includes the pair of vertically disposed and parallel side supports 14, as shown in FIGS. 1 and 2. One of the side supports 14 is common to a next-adjacent racking system 10 of the connected series of racking systems, as shown in FIG. 2. The parallel side supports 14 for each racking system 10 are laterally spaced apart at the first or lower separation distance D₁, providing the clearance space to accommodate the entrance of the fork-lift vehicle 18 therebetween, as suggested in FIG. 2.

As shown in FIGS. 1 and 2, the vertically-disposed and laterally-spaced side supports 14 of each racking system 10 define lower storage space 20 for receiving and storing the lower group of palletized items 22 therein. As shown in FIG. 1, the pair of horizontally disposed and co-planar overhead support platforms 28 each have outer end 30 secured to a respective one of the side supports 14, the outer end 30 extending towards another support platform 28. Inner ends 32 of the support platforms terminate short of each other in spaced-apart relationship to define the second or upper separation distance or clearance space D₂. Such clearance space D₂ accommodates the entrance of the vertically-extendable mast 34 of fork-lift vehicle 18 therebetween, as shown in FIG. 2. Upper storage space 36 is located on and over platforms 28 for receiving and storing the upper group of palletized cartons 38 therein.

As shown in FIGS. 1 and 2, each side support 14 of each racking system 10 comprises the plurality of vertically-disposed and longitudinally-aligned posts 16. Each post 16 terminates at a lower end 13 at an anchor plate 17 adapted to be secured to a surface 19, which may, for example, be the floor of a storage building. In the illustrative embodiment, of FIG. 1, a plurality of spaced-apart posts 16 are shown. A pair of posts 16, for example, provides a depth D₃ for racking system 10. These posts 16 are secured together by diagonally-disposed braces 21. An upper end 23 of each post 16 terminates at T-shaped upper support member 40, the support members 40 cooperating, in part, to support or to possibly form part of support platforms 28.

Each support platform 28 further comprises an elongated first runner or inner member 29 secured to distal ends 41 of support members 40 to define an inner end side 32 of a respective support platform 28. Each support platform 28 further comprises an elongated second runner or outer member 31 secured between distal ends 41 of a respective upper support member 40. Elongated members 29 and 31 may be formed as steel angles positioned to provide horizontally-disposed surfaces adapted to support and guide an underside 37 of one or more respective pallets 24 thereon. Support platforms 28, including inner members 29 and outer members 31, are configured to span depth D₃ for racking system 10 that includes the at least two pairs of vertically-disposed and laterally-spaced apart side supports 14.

A rectangular frame structure 33, as shown in FIG. 2, is integrally secured via side supports 14 and is disposed vertically above each adjacent pair of laterally-spaced support platforms 28. In an illustrative embodiment, each rectangular frame structure 33 comprises a pair of laterally-spaced upper posts 42, positioned in substantially vertical alignment with respective lower posts 16, which upper posts 42 may form extensions of posts 16. The rectangular frame structure 33, as shown in FIG. 2, thus at least partially defines upper storage space 36. Each pair of laterally-spaced upper posts 42 may be capped, for example, by a reinforcement rail 44.

As suggested in FIGS. 2 and 3, fork-lift vehicle 18 includes vertically-extendable mast 34 coupled to a carriage 25 configured to hold a plurality of forks 27. In an illustrative embodiment, forks 27 are arranged, for example, as three pairs of forks 35, each pair of forks 35 configured to engage a pallet 24. The three pair of forks 35 are configured to engage and transport three pallets 24 in the three-pallet-wide, side-by-side configuration 26. Selective extension of extendable mast 34 and raising of the carriage 25 on the mast 34, under control of an operator of the fork-lift vehicle 18, will lift the three-pallet-wide configuration 26 from, for example, ground level to a position on the overhead support platforms 28.

A method, according to the present disclosure, for storing palletized items 12 on racking system 10 is next described. A plurality of horizontally-disposed pallets 24 arranged in a three-pallet-wide side-by-side configuration 26 and having palletized items 12 stacked thereon is provided. Also provided is a fork-lift vehicle 18 having extendable mast 34 and a plurality of forwardly-projecting forks 27 arranged to simultaneously engage within the plurality of horizontally-disposed pallets 24 arranged in the three-pallet-wide side-by-side configuration 26. At least one of the racking systems 10 is provided, which at least one racking system 10 includes the pair of vertically-disposed and parallel side-supports 14 and the plurality of horizontally-disposed and co-planar overhead support platforms 28. The support platforms 28 are secured to one of the side-supports 14 and inner ends 32 of the support platforms 28 define a separation distance and clearance space D₂ to accommodate the entrance of vertically-extendable mast 34 of fork-lift vehicle 18. The support platforms 28 support or include support members 40, which support members 40 are each sized to support a full width 46 of one of the three side-by-side pallets 24 and first or end portion 48 of middle pallet 50 of the three side-by-side pallets 24, and the second or intermediate portion 52 of middle pallet 50 spans separation distance and clearance space D₂.

A fork-lift operator loads the three-pallet-wide configuration 26 on the plurality of forks 27 and vertically extends vertically-extendable mast 34 to a height above support platforms 28. The operator moves fork-lift vehicle 18 such that vertically-extended mast 34 is positioned within the separation distance and clearance space D₂ to position the three-pallet-wide configuration 26 over the support platforms 28. The operator then lowers extendable mast 34 to deposit the three-pallet-wide configuration 26 onto the support platforms 28. The three-pallet-wide configuration 26 is deposited such that two of the pallets 24 are fully supported by support platforms 28 and the third or middle pallet 50 has first or end portions 48 supported by support platforms 28 and the second or intermediate portion 52 spans the separation distance and clearance space D₂ between inner ends 32 of support platforms 28.

Although the present disclosure has been described and illustrated in detail, it is to be clearly understood that this is done by way of illustration and example only and is not to be taken by way of limitation. The scope of the present disclosure is to be limited only by the terms of the appended claims.

We claim:

1. A racking system for storing palletized items, the racking system comprising:
at least two pair of vertically-disposed side supports, the side supports being laterally spaced-apart at a first separation distance to accommodate an entrance of a fork-lift vehicle therebetween and to define a lower storage space configured to receive and store a first group of palletized items, the palletized items being stacked on three pallets arranged in a three-pallet-wide, side-by-side configuration,
a plurality of horizontally-disposed and co-planar support platforms located above the lower storage space, the support platforms each having inner ends terminating short of each other in a horizontally spaced-apart relationship to define a second separation distance and a clearance space to accommodate an entrance of a mast of the fork-lift vehicle and to at least partially define an upper storage space over the support platforms configured to receive and store a second group of palletized items, the palletized items being stacked on three pallets in a three-pallet-wide, side-by-side configuration, and
wherein each of the support platforms is configured to completely underlie and support a full width of one of the three side-by-side pallets and an end portion of a middle pallet of the three side-by-side pallets, and an intermediate portion of the middle pallet lying between the end portions spans the second separation distance.

2. The racking system of claim 1, wherein each side support includes a vertically-disposed post and a support member extending upwardly from the post and the posts of adjacent side supports are laterally-spaced from each other.

3. The racking system of claim 2, wherein each support member is T-shaped and the T-shaped support members extend laterally toward one another.

4. The racking system of claim 2, wherein each post is connected to at least one of an adjacent post of one of the side supports by a brace secured to a first end of one of the posts and to a second end of the adjacent post.

5. The racking system of claim 1, wherein each support platform includes an outer end secured to one of the side supports, the outer end including an elongated outer member spanning a distance between two side supports.

6. The racking system of claim 1, wherein the inner ends are secured to one of the side supports, the inner ends including an elongated inner member spanning a distance between two side supports.

7. The racking system of claim 1, further comprising a frame structure located above each of the support platforms, the frame structure including a pair of laterally spaced-apart upper posts secured at their lower ends to the support platforms and cooperating to at least partially define the upper storage space.

8. The racking system of claim 7, wherein the frame structure further includes a horizontally-disposed rail coupled to an upper end of each of the posts of the pair of laterally-spaced-apart upper posts.

9. The racking system of claim 1, wherein a plurality of pairs of side supports are interconnected to form a series of racking systems.

10. The racking system of claim 2, wherein each of the posts includes a lower end terminating at an anchor plate, the anchor plate configured to be secured to an underlying surface.

11. The racking system of claim 5, wherein each side support includes a support member extending upwardly therefrom.

12. The racking system of claim 11, wherein the elongated outer member is secured between distal ends of the support member.

13. The racking system of claim 6, wherein each side support includes a support member extending upwardly therefrom.

14. The racking system of claim 13, wherein the elongated inner member is secured to a distal end of the support member.

15. A racking system for storing palletized items, the racking system comprising:
a frame assembly including at least a pair of vertically-disposed side supports, the side supports being laterally spaced-apart at a first separation distance to define a first storage space therebetween, and
means for supporting a full width of a group of palletized items stacked on three pallets, the three pallets being arranged in a three-pallet-wide, side-by-side configuration in a second storage space located above the first storage space.

16. The racking system of claim 15, wherein the means includes a support member extending upwardly from an upper end of each side support and configured to underlie and support a full width of two pallets, the two pallets including one pallet from each of two different three-pallet-wide, side-by-side configurations of pallets.

17. The racking system of claim 16, wherein the means further includes a plurality of horizontally-disposed and co-planar support platforms coupled to and overlying the support members and defining the second storage space, each support platform having an inner end and an outer end, the inner ends terminating short of each other in spaced-apart relationship to define a second separation distance configured to underlie a middle portion of a middle pallet of the three-pallet-wide configuration of pallets.

18. The racking system of claim 17, wherein each support platform is configured to underlie and support a full width of one of the three pallets in the three-pallet-wide configuration of pallets.

19. The racking system of claim 16, wherein each support member is configured to underlie and support first portions of a middle pallet of the three pallets of the three-pallet-wide configuration.

20. The racking system of claim 16, wherein the support member is T-shaped and includes distal ends extending laterally toward an adjacent support member.

21. The racking system of claim 15, wherein the first storage space is configured to receive at least one of a fork-lift vehicle and a full width of a group of palletized items stacked on three pallets arranged in a three-pallet-wide, side-by-side configuration of pallets.

22. The racking system of claim 17, wherein the second separation distance is configured to receive a mast of a fork-lift vehicle, the fork lift vehicle being configured to deliver the three-pallet-wide, side-by-side configuration of pallets into the second storage space.

23. A method for storing palletized items on a racking system, the method steps comprising
a) providing a plurality of horizontally-disposed pallets arranged in a three-pallet-wide, side-by-side configuration, each pallet having palletized items stacked thereon and the side-by-side configuration including two end pallets and a middle pallet,
b) providing a fork-lift vehicle having a vertically extendable mast and a plurality of laterally-spaced and forwardly-projecting forks adapted to simultaneously engage within the plurality of horizontally disposed pallets arranged in the three-pallet-wide side-by-side configuration,
c) providing a racking system having a pair of vertically-disposed and parallel-aligned side supports and a plurality of horizontally-disposed and co-planar overhead support platforms each secured to one of the side supports, inner ends of the support platforms defining a separation distance and a clearance space to accommodate the entrance of the vertically extended mast of the fork lift vehicle, and the support platforms further including support members each sized to support a full width of one of the end pallets of the three side-by-side pallets and an end portion of the middle pallet of the three side-by-side pallets, and an intermediate portion of the middle pallet spans the separation distance,
d) loading the three-pallet-wide side-by-side configuration on the plurality of forks,
e) extending the mast vertically to raise the three-pallet-wide configuration above the plurality of support platforms,
f) moving the fork lift vehicle to position the mast within the separation distance and to position the three-pallet-wide configuration of pallets directly over the support platforms,
g) lowering the mast and depositing the three-pallet-wide configuration of pallets onto the support platforms, and
wherein the depositing step includes positioning the three-pallet-wide configuration of pallets such that the two end pallets and end portions of the middle pallet are on the support platforms and the intermediate portion of the middle pallet spans the separation distance.

24. The method of claim 23, when steps a)-g) are repeated to deposit another three-pallet-wide, side-by-side configuration of pallets on an adjacent pair of vertically-disposed side supports.
